(19) United States
(12) Patent Application Publication
(10) Pub. No.: US 2020/0037246 A1
(43) Pub. Date: Jan. 30, 2020

(54) UE POWER PROFILE ADAPTATION

(71) Applicant: Mediatek Inc., Hsin-Chu (TW)

(72) Inventors: Chien Hwa Hwang, Hsinchu (TW); Xiu-Sheng Li, Hsinchu (TW); Yiju Liao, Hsinchu (TW); Wei-De Wu, Hsinchu (TW)

(21) Appl. No.: 16/520,486

(22) Filed: Jul. 24, 2019

Related U.S. Application Data
(60) Provisional application No. 62/703,008, filed on Jul. 25, 2018.

(51) Int. Cl. H04W 52/02; H04L 29/08; H04W 72/04

(52) U.S. Cl. CPC H04W 52/0216; H04W 72/0446; H04L 67/303

(57) ABSTRACT

In an aspect of the disclosure, a method, a computer-readable medium, and an apparatus are provided. The apparatus may be a UE. The UE receives, from a base station, a configuration specifying one or more power profiles of the UE. Each of the power profile includes a predetermined value of at least one operational parameter that, while adopted by the UE when the configuration is applied, affects a power consumption of the UE. The UE operates in accordance with a first power profile of the one or more power profiles. The UE determines that a trigger event has occurred. The UE switches to operate in accordance with a second power profile of the one or more power profiles.

### CROSS-REFERENCE TO RELATED APPLICATION(S)

This application claims the benefit of U.S. Provisional Application Ser. No. 62/703,008, entitled “UE POWER PROFILE ADAPTATION” and filed on Jul. 25, 2018, which is expressly incorporated by reference herein in their entirety.

### BACKGROUND

### Field

The present disclosure relates generally to communication systems, and more particularly, to techniques employed by a user equipment (UE) for adapting different power profiles.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE receives, from a base station, a configuration specifying one or more power profiles of the UE. Each of the power profile includes a predetermined value of at least one operational parameter that, while adopted by the UE when the configuration is applied, affects a power consumption of the UE. The UE operates in accordance with a first power profile of the one or more power profiles. The UE determines that a trigger event has occurred. The UE switches to operate in accordance with a second power profile of the one or more power profiles.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric subframe.

FIG. 6 is a diagram showing an example of an UL-centric subframe.

FIG. 7 is a diagram illustrating communications between a base station and UE.

FIG. 8 is a diagram illustrating procedures of switching power profiles at the UE.

FIG. 9 is a diagram illustrating other procedures of switching power profiles at the UE.

FIG. 10 is a diagram illustrating procedures of switching power profiles when the UE operates in different RRC states.

FIG. 11 is a flow chart of a method (process) for operating in accordance with different power profiles.

FIG. 12 is a conceptual data flow diagram illustrating the data flow between different components/means in an exemplary apparatus.

FIG. 13 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

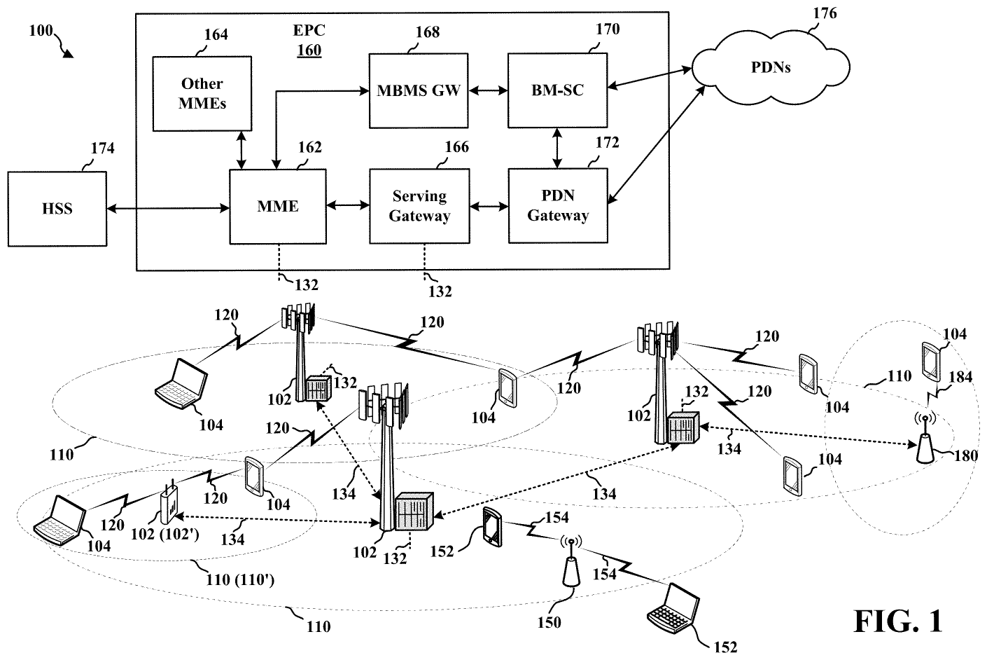

FIG. 1 is a diagram illustrating an example of a wireless communications system and an access network 100. The wireless communications system (also referred to as a wireless wide area network (WWAN)) includes base stations 102, UEs 104, and a core network 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the core network 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the core network 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 1 10. For example, the small cell 102′ may have a coverage area 110′ that overlaps the coverage area 1 10 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The core network 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the core network 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the core network 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

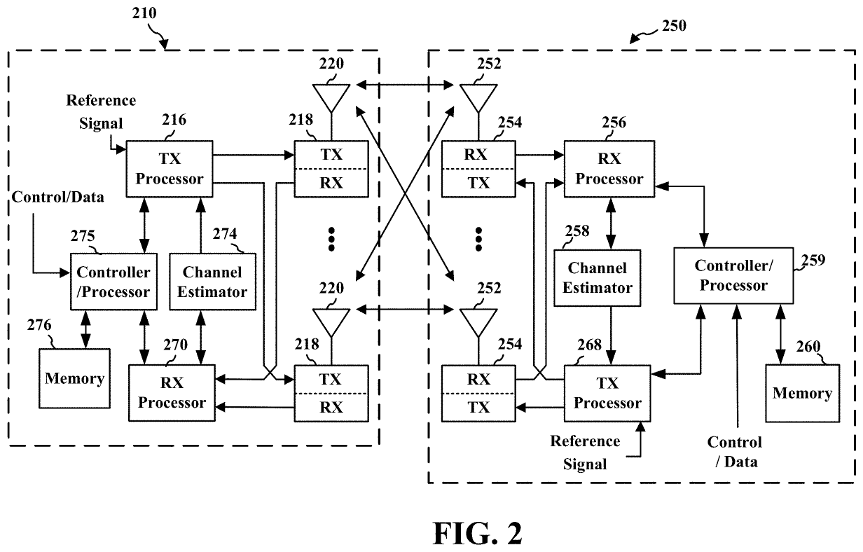

FIG. 2 is a block diagram of a base station 210 in communication with a UE 250 in an access network. In the DL, IP packets from the core network 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the core network 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the core network 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

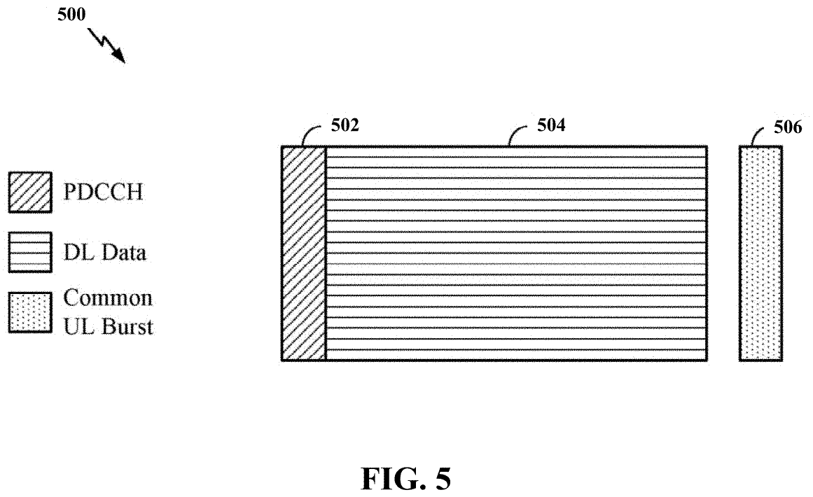

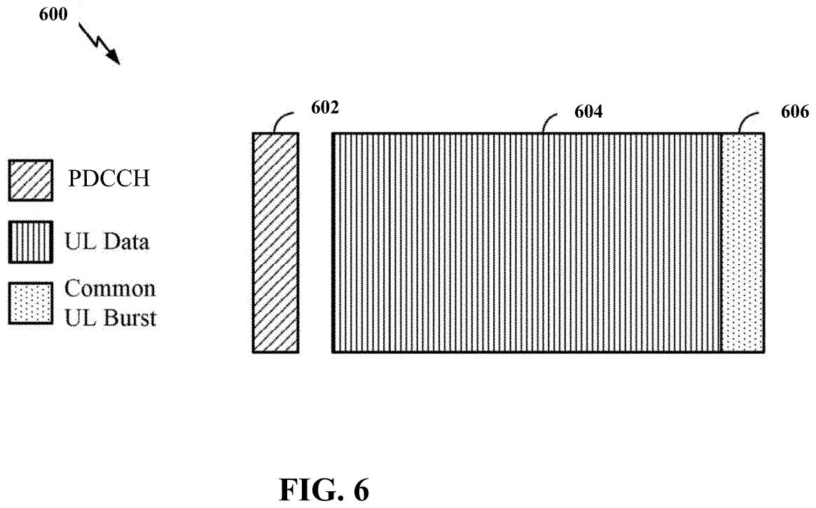

A single component carrier bandwidth of 100 MHZ may be supported. In one example, NR resource blocks (RBs) may span 12 sub-carriers with a sub-carrier bandwidth of 60 kHz over a 0.125 ms duration or a bandwidth of 15 kHz over a 0.5 ms duration. Each radio frame may consist of 20 or 80 subframes (or NR slots) with a length of 10 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases, DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

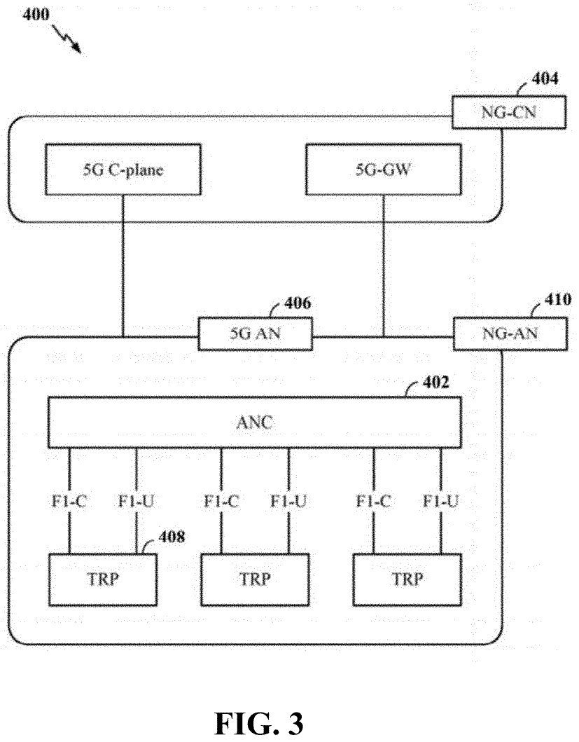

FIG. 3 illustrates an example logical architecture 300 of a distributed RAN, according to aspects of the present disclosure. A 5G access node 306 may include an access node controller (ANC) 302. The ANC may be a central unit (CU) of the distributed RAN 300. The backhaul interface to the next generation core network (NG-CN) 304 may terminate at the ANC. The backhaul interface to neighboring next generation access nodes (NG-ANs) may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

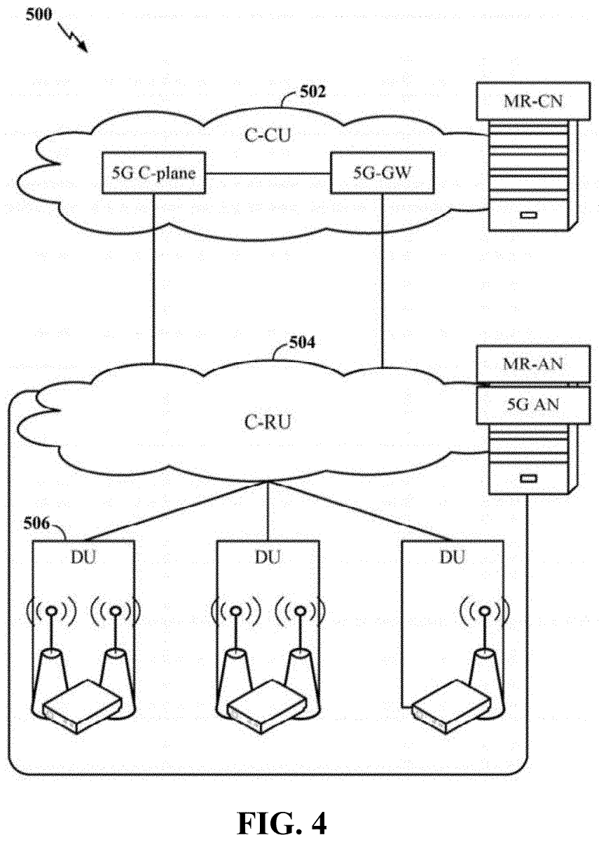

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric subframe. The DL-centric subframe may include a control portion 502. The control portion 502 may exist in the initial or beginning portion of the DL-centric subframe. The control portion 502 may include various scheduling information and/or control information corresponding to various portions of the DL-centric subframe. In some configurations, the control portion 502 may be a physical DL control channel (PDCCH), as indicated in FIG. 5. The DL-centric subframe may also include a DL data portion 504. The DL data portion 504 may sometimes be referred to as the payload of the DL-centric subframe. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric subframe may also include a common UL portion 506. The common UL portion 506 may sometimes be referred to as an UL burst, a common UL burst, and/or various other suitable terms. The common UL portion 506 may include feedback information corresponding to various other portions of the DL-centric subframe. For example, the common UL portion 506 may include feedback information corresponding to the control portion 502. Non-limiting examples of feedback information may include an ACK signal, aNACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 6 is a diagram 600 showing an example of an UL-centric subframe. The UL-centric subframe may include a control portion 602. The control portion 602 may exist in the initial or beginning portion of the UL-centric subframe. The control portion 602 in FIG. 6 may be similar to the control portion 502 described above with reference to FIG. 5. The UL-centric subframe may also include an UL data portion 604. The UL data portion 604 may sometimes be referred to as the pay load of the UL-centric subframe. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 606. The common UL portion 606 in FIG. 6 may be similar to the common UL portion 606 described above with reference to FIG. 6. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

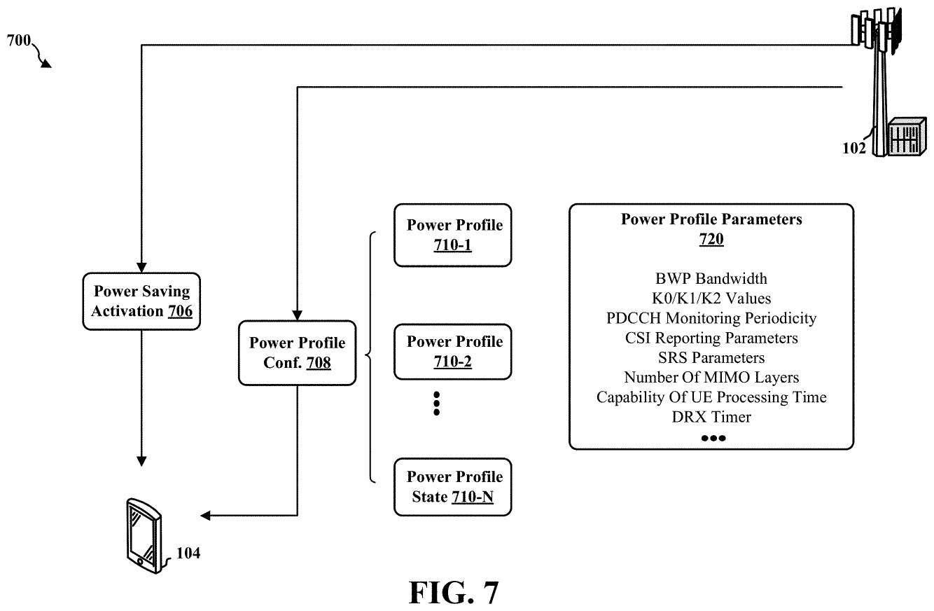

FIG. 7 is a diagram 700 illustrating communications between a base station 702 and a UE 704. Upon being connected with the base station 702, the UE 704 may receive an activation message 706 that instructs the UE 704 to enter into power saving procedures. Subsequently, when the power saving procedures of the UE 704 are activated, the UE 704 receives a power profile configuration 708 from the base station 702. The activation message 706 and the power profile configuration 708 may each be carried by a Radio Resource Control (RRC) message, a medium access control (MAC) control element (CE), or DCI of a PDCCH. Based on the power profile configuration 708, the UE 704 can create or obtain power profiles 710-1, 710-2, . . . , 710-N. N is an integer greater than 0. Each power profile of the power profiles 710-1, 710-2, . . . , 710-N specifies values of one or more of power profile parameters 720.

For example, the power profile parameters 720 may include a bandwidth part parameter that specifies a bandwidth part on which the UE 704 is operating. The power profile parameters 720 may include a processing time parameter that specifies a processing time allocated to the UE 704 to decode a downlink control channel according to a slot offset between the downlink control channel and the associated downlink data channel. The power profile parameters 720 may include another processing time parameter that specifies a processing time allocated to the UE 704 to prepare an acknowledgement for a downlink data channel according to a slot offset between a downlink data channel and the associated acknowledgement. The power profile parameters 720 may include a processing time parameter that specifies a processing time allocated to the UE 704 to prepare an uplink channel according to a slot offset between a downlink control channel and the associated uplink data channel. In particular, the power profile parameters 720 includes parameters K₀, K₁, and/or K₂ as defined in “3GPP TS 38.214 V15.2.0 (2018-06); 3rd Generation Partnership Project; Technical Specification Group Radio Access Network; NR; Physical layer procedures for data (Release 15),” which is expressly incorporated by reference herein in its entirety. In one example, when the values of the K₀, K₁, and/or K₂ are larger, the UE 704 may process signals at a lower speed, hence using less power.

The power profile parameters 720 may include a channel state information (CSI) parameter specifying a processing time allocated to the UE for preparing a report for channel state information. The power profile parameters 720 may include a Sounding Reference Signal (SRS) parameter specifying a processing time allocated to the UE for preparing an action of the UE for transmitting Sounding Reference Signals.

The power profile parameters 720 may include a multiple-input and multiple-output (MIMO) parameter specifying a maximum number of MIMO layers to be used by the UE. In one example, when the UE 704 communicates with the base station 702 using more MIMO layers, the UE 704 may use more power to process and communicate signals.

The power profile parameters 720 may further include a capability parameter specifying a processing time allocated to the UE for preparing downlink data channel according to a downlink data channel processing capability or for preparing uplink data channel according to an uplink data channel processing capability.

The power profile parameters 720 may include a Discontinuous Reception (DRX) timer parameter specifying a time interval of a timer that causes the UE to enter into a DRX cycle after expiration. The UE 704 resets/restarts the timer when the UE receives or transmitting data.

After the UE 704 selects one of the power profiles 710-1, 710-2, . . . , 710-N, the UE 704 operates in accordance with the values of the power profile parameters 720 as set in the selected power profile. With different values of the power profile parameters 720 in different power profiles, the UE 704 consumes different amount of energy when operating in accordance with the different power profiles.

Further, one of the power profiles 710-1, 710-2, . . . , 710-N may be designated as a power efficient power profile in the power profile configuration 708. For example, when adopted by the UE, the power efficient power profile causes the UE 704 to consume energy less than energy consumed by the UE 704 when any other one of the power profiles 710-1, 710-2, . . . , 710-N is adopted by the UE. As described infra, the UE 704 may select this power efficient power profile as a default power profile under certain conditions.

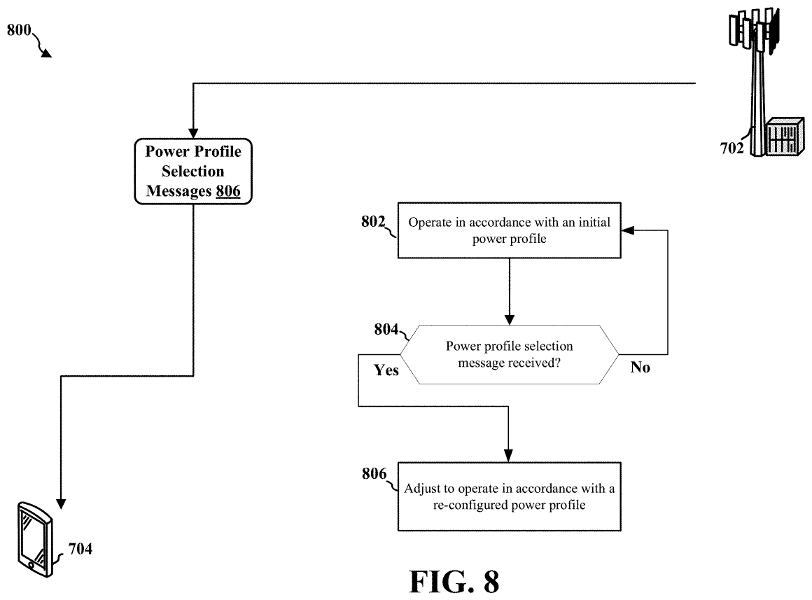

FIG. 8 is a diagram illustrating procedures of switching power profiles at the UE 704. As described supra, upon receiving the activation message 706, the UE 704 receives the power profile configuration 708 from the base station 702. Subsequently, the UE 704 may receive a power profile selection message 806 from the base station 702. The power profile selection message 806 may indicate one of the power profiles 710-1, 710-2, . . . , 710-N for the UE 704 to adopt. For example. the power profile configuration 708 may include indices referencing the power profiles 710-1, 710-2, . . . , 710-N. Accordingly, the power profile selection message 806 may include a particular index corresponding to a particular power profile. The UE 704 extracts the index from the power profile selection message 806 and can determine the power profile to use according to the index.

More specifically, at procedure 802, the UE 704 operates in accordance with an initial power profile of the power profiles 710-1, 710-2, . . . , 710-N, which is a default power profile or was indicated in an initial power profile selection message 806.

The base station 702 monitors data traffic characteristics and/or channel conditions at the UE 704. For example, the base station 702 may detect that the UE 704 is about to receive a larger amount of data starting from the next slot or the next predetermined number of slots. Accordingly, the base station 702 may send a power profile selection message 806 indicating the UE 704 to switch to using a particular power profile of the power profiles 710-1, 710-2, . . . , 710-N upon receiving the power profile selection message 806 or starting from a particular slot. The power profile selection message 806 may be carried by an RRC message, a MAC CE, or DCI of a PDCCH.

At the UE side, at procedure 804, the UE 704 monitors whether a power profile selection message 806 is received. When no new power profile selection message 806 is received, the UE 704 goes back to the procedure 802, in which the UE 704 operates in accordance with the initial power profile. When the UE 704 detects a power profile selection message 806, the UE 704 enters procedure 806, in which the UE 704 adopts the power profile indicated in the power profile selection message 806 and accordingly adjusts relevant hardware, software, and/or radio frequency settings. As described supra, the power profile includes values for one or more of the power profile parameters 720. In one example, the UE 704 may accordingly change to a different bandwidth part, and use different K₀, K₁, and/or K₂ values.

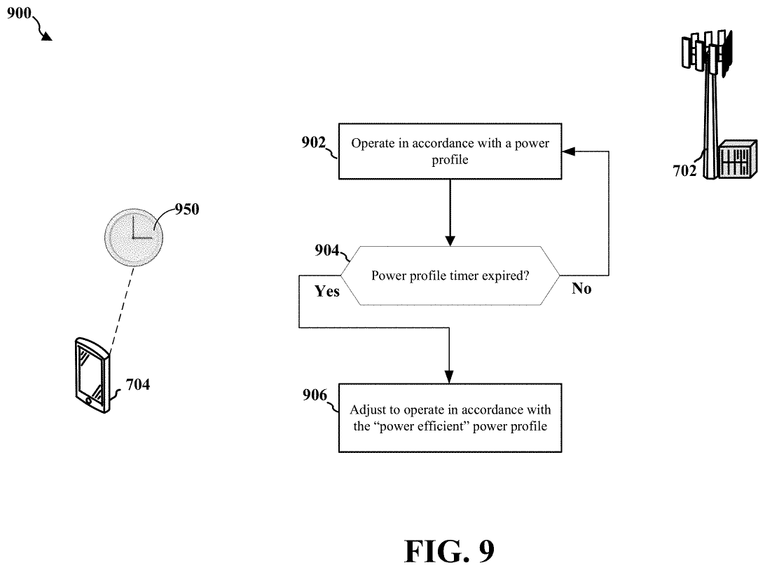

FIG. 9 is a diagram illustrating other procedures of switching power profiles at the UE 704. In this example, the UE 704 has a power profile timer 950 that expires at a predetermined time duration. The power profile timer 950 starts to run when the UE 704 adopts a particular power profile of the power profiles 710-1, 710-2, . . . , 710-N. The power profile timer 950 resets to 0 or its initial state whenever the UE 704 starts a data transmission to the base station 702 or a data reception from the base station 702. The power profile timer 950 restarts when the UE 704 completes a data transmission to the base station 702 or a data reception from the base station 702. In other words, the power profile timer 950 expires when there are no data transmission/reception activities for the predetermined time duration.

More specifically, at procedure 902, the UE 704 operates in accordance with a currently adopted power profile of the power profiles 710-1, 710-2, . . . , 710-N. At procedure 904, the UE 704 determines whether the power profile timer 950 has expired. When the power profile timer 950 has not expired, the UE 704 enters back to procedure 902. When the power profile timer 950 has expired, the UE 704 enters procedure 906, in which the UE 704 switch to adopting a default power profile such as the power efficient power profile described supra and accordingly adjusting relevant hardware, software, and/or radio frequency settings. For example, the bandwidth part parameter may specify a bandwidth part having the smallest bandwidth.

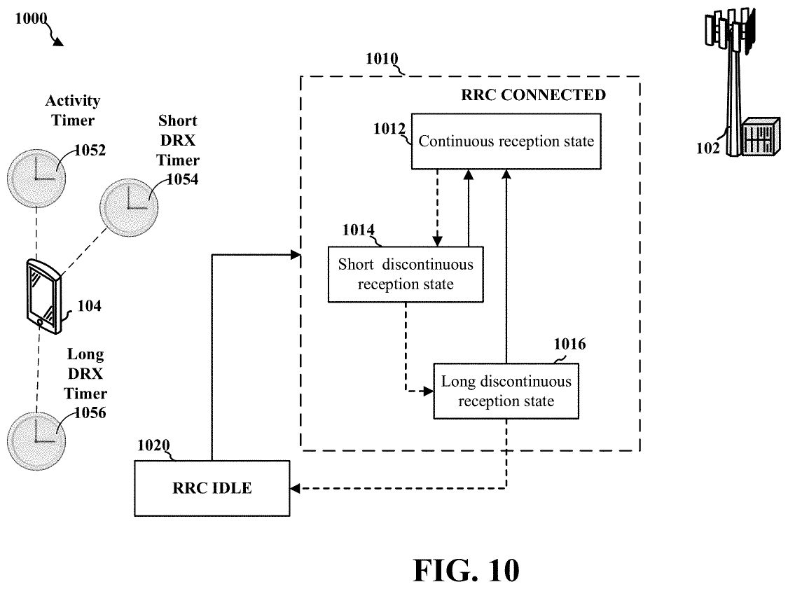

FIG. 10 is a diagram illustrating procedures of switching power profiles when the UE 704 operates in different RRC states. In this example, the UE 704 initially is in an RRC CONNECTED state 1010. Further, the UE 704 implement a Discontinuous Reception (DRX) mechanism. The basic mechanism for DRX is a configurable DRX cycle in the UE 704. With a DRX cycle configured with an ON duration and an OFF duration, the device monitors the downlink control signaling only when active (i.e., in the ON duration), sleeping with the receiver circuitry switched off the remaining time (i.e., in the OFF duration). This allows for a significant reduction in power consumption: the longer the cycle, the lower the power consumption. Naturally, this implies restrictions to the scheduler as the device can be addressed only when active according to the DRX cycle. In this example, the UE 704 may operate in a short DRX state 1014 or a long DRX state 1016 under certain conditions. The DRX cycle of the short DRX state 1014 is shorter than that of the long DRX state 1016. As such, in this example, within the RRC CONNECTED state 1010, the UE 704 can be in one of a continuous reception state 1012, the short DRX state 1014, and the long DRX state 1016.

When the UE 704 is in the continuous reception state 1012, the UE 704 monitors PDCCHs continuously. When the UE 704 is in the short DRX state 1014 or the long DRX state 1016, the UE 704 monitors PDCCHs in each ON duration (i.e., discontinuously). Further, when the UE 704 is in the continuous reception state 1012, the UE 704 can receive the power profile selection message 806 as described supra and can switch to different power profiles accordingly. For example, the traffic characteristics at the UE 704 may have changed such as when the UE 704 starts to communicate larger amount of data with the base station 702. The base station 702 may notice the changes and may send a power profile selection message 806 to the UE 704 to change the power profile adopted at the UE 704. The UE 704 may consume more power with the new power profile as the UE 704 needs to process more data.

Further, the UE 704 may be configured with an activity DRX timer 1052 that expires at a first predetermined time duration. The activity DRX timer 1052 starts when the UE 704 completes a data transmission to the base station 702 or a data reception from the base station 702. The activity DRX timer 1052 resets to 0 or its initial state whenever the UE 704 starts a data transmission. The UE 704 switches to operating in the short DRX state 1014 when the activity DRX timer 1052 expires or when instructed by the base station 702. In other words, when the UE 704 in the continuous reception state 1012 has not communicated with the base station 702 for the first predetermined time duration, the UE 704 enters the short DRX state 1014. The UE 704 may also switch to a power profile of the power profiles 710-1, 710-2, . . . , 710-N that corresponds to the short DRX state 1014.

Subsequently, the base station 702 may transmit a signal to the UE 704 in an ON duration of the short DRX cycle to wake up the UE 704. In one configuration, at the same time, the base station 702 may also transmit to the UE 704 a power profile selection message 806 indicating a power profile for the UE 704 to adopt once switching back to the continuous reception state 1012. In another configuration, once the UE 704 determines to switch to the continuous reception state 1012 upon receiving the signal in the ON duration, the UE 704 may also determine to switch to a different power profile corresponding to the continuous reception state 1012.

Further, the UE 704 may be configured with a short DRX timer 1054 that expires at a second predetermined time duration. The short DRX timer 1054 starts when the UE 704 enters into the short DRX state 1014. The short DRX timer 1054 resets to 0 or its initial state whenever the UE 704 switches to the continuous reception state 1012 from the short DRX state 1014. The UE 704 switches to operating in the long DRX state 1016 when the short DRX timer 1054 expires or when instructed by the base station 702. In other words, after the UE 704 is in the short DRX state 1014 for the second predetermined time duration, the UE 704 enters the long DRX state 1016. The UE 704 may also switch to a power profile of the power profiles 710-1, 710-2, . . . , 710-N that corresponds to the long DRX state 1016.

Subsequently, the base station 702 may transmit a signal to the UE 704 in an ON duration of the long DRX cycle to wake up the UE 704. In one configuration, at the same time, the base station 702 may also transmit to the UE 704 a power profile selection message 806 indicating a power profile for the UE 704 to adopt once switching back to the continuous reception state 1012. In another configuration, once the UE 704 determines to switch to the continuous reception state 1012 upon receiving the signal in the ON duration, the UE 704 may also determine to switch to a different power profile corresponding to the continuous reception state 1012.

Further, the UE 704 may be configured with a long DRX timer 1056 that expires at a third predetermined time duration. The long DRX timer 1056 starts when the UE 704 enters into the long DRX state 1016. The long DRX timer 1056 resets to 0 or its initial state whenever the UE 704 switches to the continuous reception state 1012 from the long DRX state 1016. The UE 704 switches to an RRC IDLE state 1020 when the long DRX timer 1056 expires or when instructed by the base station 702. In other words, after the UE 704 is in the long DRX state 1016 for the third predetermined time duration, the UE 704 enters the RRC IDLE state 1020. The UE 704 may also switch to a power profile of the power profiles 710-1, 710-2, . . . , 710-N that corresponds to the RRC IDLE state 1020.

Subsequently, the base station 702 may transmit to the UE 704 in the RRC IDLE state 1020 a signal instructing the UE 704 to switch to the RRC CONNECTED state 1010. In one configuration, at the same time, the base station 702 may also transmit to the UE 704 a power profile selection message 806 indicating a power profile for the UE 704 to adopt once switching back to the RRC CONNECTED state 1010. In another configuration, once the UE 704 determines to switch to the RRC CONNECTED state 1010 upon receiving the signal, the UE 704 may also determine to switch to a different power profile corresponding to the RRC CONNECTED state 1010.

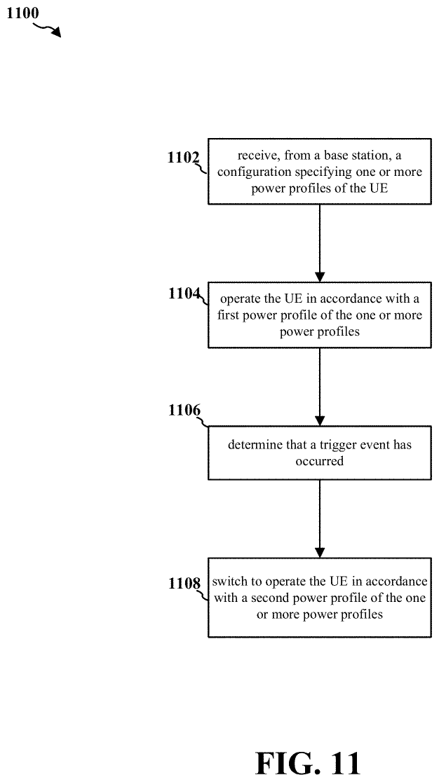

FIG. 11 is a flow chart 1100 of a method (process) for operating in accordance with different power profiles. The method may be performed by a UE (e.g., the UE 704, the apparatus 1202, and the apparatus 1202′). At operation 1102, the UE receives, from a base station, a configuration specifying one or more power profiles of the UE. Each of the power profile includes a predetermined value of at least one operational parameter that, while adopted by the UE when the configuration is applied, affects a power consumption of the UE. At operation 1104, the UE operates in accordance with a first power profile of the one or more power profiles. At operation 1106, the UE determines that a trigger event has occurred. At operation 1108, the UE switches to operate in accordance with a second power profile of the one or more power profiles.

In certain configurations, the configuration is received through at least one of a Radio Resource Control (RRC) message, a medium access control (MAC) control element (CE), and a down link control channel.

In certain configurations, the at least one operational parameter specifies one or more of: (a) a bandwidth part on which the UE is operating; (b) a processing time allocated to the UE to decode a downlink control channel according to a slot offset between the downlink control channel and the associated downlink data channel, to prepare an acknowledgement for a downlink data channel according to a slot offset between a downlink data channel and the associated acknowledgement, or to prepare an uplink data channel according to a slot offset between a downlink control channel and the associated uplink data channel; (c) a processing time allocated to the UE for preparing a report for channel state information (CSI); (d) an action of the UE for reporting an aperiodic CSI; (e) an action of the UE for transmitting Sounding Reference Signals; (f) a maximum number of multiple-input and multiple-output (MIMO) layers to be used by the UE; (g) a processing time allocated to the UE for preparing downlink data channel according to a downlink data channel processing capability or for preparing uplink data channel according to an uplink data channel processing capability; (h) a duration specifying a time interval of a timer that causes the UE to enter into a Discontinuous Reception (DRX) cycle after expiration, In certain configurations, the UE resets the timer when the UE receives or transmitting data.

In certain configurations, the trigger event is that a predetermined time duration, during which the UE did not receive or transmit data, has passed. In certain configurations, the second power profile is a power profile among the one or more power profiles that, when adopted by the UE, causes the UE to consume energy less than energy consumed by the UE when any other one of the one or more power profiles is adopted by the UE.

In certain configurations, the trigger event is that the UE has received a power configuration message indicating that the second power profile is to be adopted. In certain configurations, the power configuration message is received through at least one of a Radio Resource Control (RRC) message, a medium access control (MAC) control element (CE), and a down link control channel. In certain configurations, the power configuration message is received in response to, when the UE is in a Radio Resource Control (RRC) connected state, a change of data traffic characteristic at the UE.

In certain configurations, the power configuration message is received subsequent to that the UE transfers from a Discontinuous Reception (DRX) state to a continuous reception state, In certain configurations, the first power profile is designated for the UE to adopt when the UE is in the DRX state, where the second power profile is designated for the UE to use when the UE is in the RRC connected state. In certain configurations, the DRX state is a short DRX state. In certain configurations, the DRX state is a long DRX state. In certain configurations, the power configuration message is received subsequent to that the UE transfers from a Radio Resource Control (RRC) idle state to an RRC connected state, In certain configurations, the first power profile is designated for the UE to adopt when the UE is in the RRC idle state, where the second power profile is designated for the UE to use when the UE is in the RRC connected state.

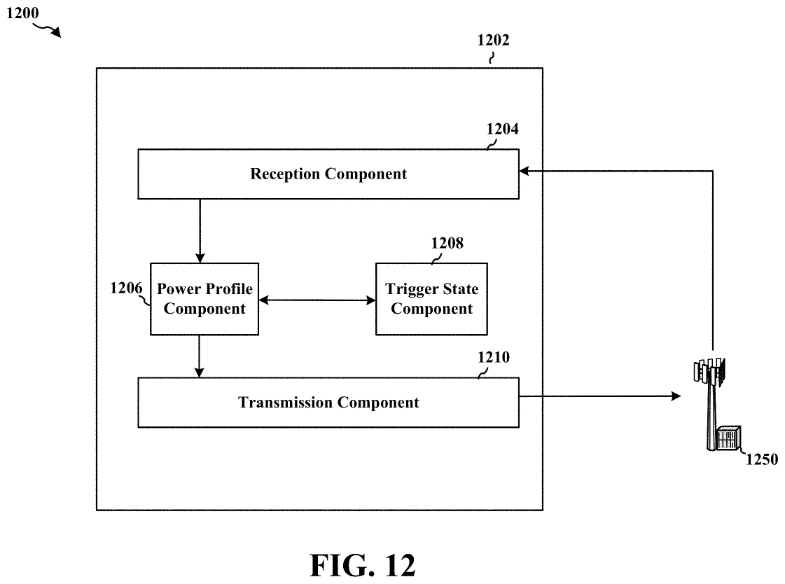

FIG. 12 is a conceptual data flow diagram 1200 illustrating the data flow between different components/means in an exemplary apparatus 1202. The apparatus 1202 may be a base station. The apparatus 1202 includes a reception component 1204, a power profile component 1206, a trigger state component 1208, and a transmission component 1210.

The power profile component 1206 receives, from a base station, a configuration specifying one or more power profiles of the UE. Each of the power profile includes a predetermined value of at least one operational parameter that, while adopted by the UE when the configuration is applied, affects a power consumption of the UE. The power profile component 1206 operates the apparatus 1202 in accordance with a first power profile of the one or more power profiles. The trigger state component 1208 determines that a trigger event has occurred. The power profile component 1206 switches to operate the apparatus 1202 in accordance with a second power profile of the one or more power profiles.

In certain configurations, the configuration is received through at least one of a Radio Resource Control (RRC) message, a medium access control (MAC) control element (CE), and a down link control channel.

In certain configurations, the at least one operational parameter specifies one or more of: (a) a bandwidth part on which the UE is operating; (b) a processing time allocated to the UE to decode a downlink control channel according to a slot offset between the downlink control channel and the associated downlink data channel, to prepare an acknowledgement for a downlink data channel according to a slot offset between a downlink data channel and the associated acknowledgement, or to prepare an uplink data channel according to a slot offset between a downlink control channel and the associated uplink data channel; (c) a processing time allocated to the UE for preparing a report for channel state information (CSI); (d) an action of the UE for reporting an aperiodic CSI; (e) an action of the UE for transmitting Sounding Reference Signals; (f) a maximum number of multiple-input and multiple-output (MIMO) layers to be used by the UE; (g) a processing time allocated to the UE for preparing downlink data channel according to a downlink data channel processing capability or for preparing uplink data channel according to an uplink data channel processing capability; (h) a duration specifying a time interval of a timer that causes the UE to enter into a Discontinuous Reception (DRX) cycle after expiration, In certain configurations, the UE resets the timer when the UE receives or transmitting data.

In certain configurations, the trigger event is that a predetermined time duration, during which the UE did not receive or transmit data, has passed. In certain configurations, the second power profile is a power profile among the one or more power profiles that, when adopted by the UE, causes the UE to consume energy less than energy consumed by the UE when any other one of the one or more power profiles is adopted by the UE.

In certain configurations, the trigger event is that the UE has received a power configuration message indicating that the second power profile is to be adopted. In certain configurations, the power configuration message is received through at least one of a Radio Resource Control (RRC) message, a medium access control (MAC) control element (CE), and a down link control channel. In certain configurations, the power configuration message is received in response to, when the UE is in a Radio Resource Control (RRC) connected state, a change of data traffic characteristic at the UE.

In certain configurations, the power configuration message is received subsequent to that the UE transfers from a Discontinuous Reception (DRX) state to a continuous reception state, In certain configurations, the first power profile is designated for the UE to adopt when the UE is in the DRX state, where the second power profile is designated for the UE to use when the UE is in the RRC connected state. In certain configurations, the DRX state is a short DRX state. In certain configurations, the DRX state is a long DRX state. In certain configurations, the power configuration message is received subsequent to that the UE transfers from a Radio Resource Control (RRC) idle state to an RRC connected state, In certain configurations, the first power profile is designated for the UE to adopt when the UE is in the RRC idle state, where the second power profile is designated for the UE to use when the UE is in the RRC connected state.

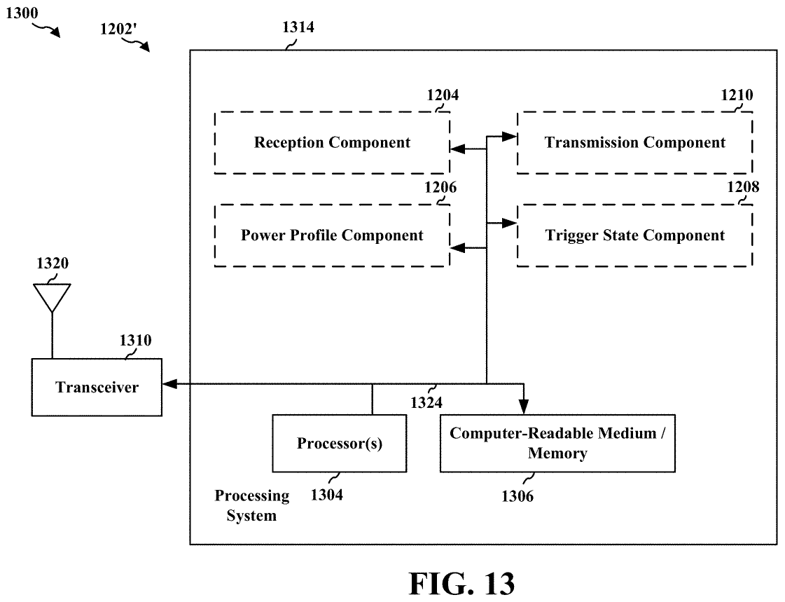

FIG. 13 is a diagram 1300 illustrating an example of a hardware implementation for an apparatus 1202′ employing a processing system 1314. The apparatus 1202′ may be a UE. The processing system 1314 may be implemented with a bus architecture, represented generally by a bus 1324. The bus 1324 may include any number of interconnecting buses and bridges depending on the specific application of the processing system 1314 and the overall design constraints. The bus 1324 links together various circuits including one or more processors and/or hardware components, represented by one or more processors 1304, the reception component 1204, the power profile component 1206, the trigger state component 1208, the transmission component 1210, the configuration component 1212, and a computer-readable medium/memory 1306. The bus 1324 may also link various other circuits such as timing sources, peripherals, voltage regulators, and power management circuits, etc.

The processing system 1314 may be coupled to a transceiver 1310, which may be one or more of the transceivers 354. The transceiver 1310 is coupled to one or more antennas 1320, which may be the communication antennas 352.

The transceiver 1310 provides a means for communicating with various other apparatus over a transmission medium. The transceiver 1310 receives a signal from the one or more antennas 1320, extracts information from the received signal, and provides the extracted information to the processing system 1314, specifically the reception component 1204. In addition, the transceiver 1310 receives information from the processing system 1314, specifically the transmission component 1210, and based on the received information, generates a signal to be applied to the one or more antennas 1320.

The processing system 1314 includes one or more processors 1304 coupled to a computer-readable medium/memory 1306. The one or more processors 1304 are responsible for general processing, including the execution of software stored on the computer-readable medium/memory 1306. The software, when executed by the one or more processors 1304, causes the processing system 1314 to perform the various functions described supra for any particular apparatus. The computer-readable medium/memory 1306 may also be used for storing data that is manipulated by the one or more processors 1304 when executing software. The processing system 1314 further includes at least one of the reception component 1204, the power profile component 1206, the trigger state component 1208, and the transmission component 1210. The components may be software components running in the one or more processors 1304, resident/stored in the computer readable medium/memory 1306, one or more hardware components coupled to the one or more processors 1304, or some combination thereof. The processing system 1314 may be a component of the UE 350 and may include the memory 360 and/or at least one of the TX processor 368, the RX processor 356, and the communication processor 359.

In one configuration, the apparatus 1202/apparatus 1202′ for wireless communication includes means for performing each of the operations of FIG. 11. The aforementioned means may be one or more of the aforementioned components of the apparatus 1202 and/or the processing system 1314 of the apparatus 1202′ configured to perform the functions recited by the aforementioned means.

As described supra, the processing system 1314 may include the TX Processor 368, the RX Processor 356, and the communication processor 359. As such, in one configuration, the aforementioned means may be the TX Processor 368, the RX Processor 356, and the communication processor 359 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving, from a base station, a configuration specifying one or more power profiles of the UE, each of the power profile including a predetermined value of at least one operational parameter that, while adopted by the UE when the configuration is applied, affects a power consumption of the UE;
operating the UE in accordance with a first power profile of the one or more power profiles;
determining that a trigger event has occurred; and
switching to operate the UE in accordance with a second power profile of the one or more power profiles.

2. The method of claim 1, wherein the configuration is received through at least one of a Radio Resource Control (RRC) message, a medium access control (MAC) control element (CE), and a down link control channel.

3. The method of claim 1, wherein the at least one operational parameter specifies one or more of:
a bandwidth part on which the UE is operating;
a processing time allocated to the UE to decode a downlink control channel according to a slot offset between the downlink control channel and the associated downlink data channel, to prepare an acknowledgement for a downlink data channel according to a slot offset between a downlink data channel and the associated acknowledgement, or to prepare an uplink data channel according to a slot offset between a downlink control channel and the associated uplink data channel;
a processing time allocated to the UE for preparing a report for channel state information (CSI);
an action of the UE for reporting an aperiodic CSI;
an action of the UE for transmitting Sounding Reference Signals;
a maximum number of multiple-input and multiple-output (MIMO) layers to be used by the UE;
a processing time allocated to the UE for preparing downlink data channel according to a downlink data channel processing capability or for preparing uplink data channel according to an uplink data channel processing capability; and
a duration specifying a time interval of a timer that causes the UE to enter into a Discontinuous Reception (DRX) cycle after expiration, wherein the UE resets the timer when the UE receives or transmitting data.

4. The method of claim 1, wherein the trigger event is that a predetermined time duration, during which the UE did not receive or transmit data, has passed.

5. The method of claim 4, wherein the second power profile is a power profile among the one or more power profiles that, when adopted by the UE, causes the UE to consume energy less than energy consumed by the UE when any other one of the one or more power profiles is adopted by the UE.

6. The method of claim 1, wherein the trigger event is that the UE has received a power configuration message indicating that the second power profile is to be adopted.

7. The method of claim 6, wherein the power configuration message is received through at least one of a Radio Resource Control (RRC) message, a medium access control (MAC) control element (CE), and a down link control channel.

8. The method of claim 6, wherein the power configuration message is received in response to, when the UE is in a Radio Resource Control (RRC) connected state, a change of data traffic characteristic at the UE.

9. The method of claim 6, wherein the power configuration message is received subsequent to that the UE transfers from a Discontinuous Reception (DRX) state to a continuous reception state, wherein the first power profile is designated for the UE to adopt when the UE is in the DRX state, where the second power profile is designated for the UE to use when the UE is in the RRC connected state.

10. The method of claim 9, wherein the DRX state is a short DRX state.

11. The method of claim 9, wherein the DRX state is a long DRX state.

12. The method of claim 6, wherein the power configuration message is received subsequent to that the UE transfers from a Radio Resource Control (RRC) idle state to an RRC connected state, wherein the first power profile is designated for the UE to adopt when the UE is in the RRC idle state, where the second power profile is designated for the UE to use when the UE is in the RRC connected state.

13. An apparatus for wireless communication, the apparatus being a user equipment (UE), comprising:
a memory; and
at least one processor coupled to the memory and configured to:
receive, from a base station, a configuration specifying one or more power profiles of the UE, each of the power profile including a predetermined value of at least one operational parameter that, while adopted by the UE when the configuration is applied, affects a power consumption of the UE;
operate the UE in accordance with a first power profile of the one or more power profiles;
determine that a trigger event has occurred; and
switch to operate the UE in accordance with a second power profile of the one or more power profiles.

14. The apparatus of claim 13, wherein the configuration is received through at least one of a Radio Resource Control (RRC) message, a medium access control (MAC) control element (CE), and a down link control channel.

15. The apparatus of claim 13, wherein the at least one operational parameter specifies one or more of:
a bandwidth part on which the UE is operating;
a processing time allocated to the UE to decode a downlink control channel according to a slot offset between the downlink control channel and the associated downlink data channel, to prepare an acknowledgement for a downlink data channel according to a slot offset between a downlink data channel and the associated acknowledgement, or to prepare an uplink data channel according to a slot offset between a downlink control channel and the associated uplink data channel;
a processing time allocated to the UE for preparing a report for channel state information (CSI);
an action of the UE for reporting an aperiodic CSI;
an action of the UE for transmitting Sounding Reference Signals;
a maximum number of multiple-input and multiple-output (MIMO) layers to be used by the UE;
a processing time allocated to the UE for preparing downlink data channel according to a downlink data channel processing capability or for preparing uplink data channel according to an uplink data channel processing capability; and
a duration specifying a time interval of a timer that causes the UE to enter into a Discontinuous Reception (DRX) cycle after expiration, wherein the UE resets the timer when the UE receives or transmitting data.

16. The apparatus of claim 13, wherein the trigger event is that a predetermined time duration, during which the UE did not receive or transmit data, has passed.

17. The apparatus of claim 16, wherein the second power profile is a power profile among the one or more power profiles that, when adopted by the UE, causes the UE to consume energy less than energy consumed by the UE when any other one of the one or more power profiles is adopted by the UE.

18. The apparatus of claim 13, wherein the trigger event is that the UE has received a power configuration message indicating that the second power profile is to be adopted.

19. The apparatus of claim 18, wherein the power configuration message is received through at least one of a Radio Resource Control (RRC) message, a medium access control (MAC) control element (CE), and a down link control channel.

20. A computer-readable medium storing computer executable code for wireless communication of a user equipment (UE), comprising code to:
receive, from a base station, a configuration specifying one or more power profiles of the UE, each of the power profile including a predetermined value of at least one operational parameter that, while adopted by the UE when the configuration is applied, affects a power consumption of the UE;
operate the UE in accordance with a first power profile of the one or more power profiles;
determine that a trigger event has occurred; and
switch to operate the UE in accordance with a second power profile of the one or more power profiles.
